(19) United States
(12) Patent Application Publication
(10) Pub. No.: US 2015/0231870 A1
(43) Pub. Date: Aug. 20, 2015

(54) Method for joining a first component to a second component with the aid of laser welding

(71) Applicant: Robert Bosch GmbH, Stuttgart (DE)

(72) Inventors: Arne DANNENBERG, Metzingen (DE); Michael Hortig, Eningen (DE)

(21) Appl. No.: 14/614,525

(22) Filed: Feb. 5, 2015

(30) Foreign Application Priority Data
Feb. 18, 2014 (DE) 10 2014 202 919.8

(51) Int. Cl. B32B 38/00; B01L 3/00; B32B 37/06; B32B 37/00; B32B 37/18; B32B 37/15

(52) U.S. Cl. CPC B32B 38/0008; B32B 37/182; B32B 37/15; B32B 37/06; B32B 37/0076; B32B 38/0012; B32B 38/0004; B01L 3/502707; B32B 2307/412; B32B 2398/20; B32B 2551/00

(57) ABSTRACT

In a method for welding a first component having a channel to a second component, a lower surface of the first component is placed onto an upper surface of the second component, and a laser beam is transmitted through the first component and guided along a trajectory across the upper surface of the second component. The second component absorbs the laser beam along the irradiated trajectory, so that the irradiated trajectory of the second component is welded to the lower surface of the component in the form of a welding path. The channel has a rounded surface in a plane in which the laser beam is guided. The rounded surface is configured in such a way that a predefined power density of the laser beam is present at the upper surface, so that a continuous welding path is provided along the irradiated trajectory between the two components.

### BACKGROUND OF THE INVENTION

1. Field of the Invention

The present invention relates to a method for joining two components with the aid of laser welding.

2. Description of the Related Art

From Manuela Schmidt's printed publication “Untersuchung zum Aufbau hybrider Mikrosysteme unter Verwendung von Polymermaterialien” [Examination Regarding the Structure of Hybrid Microsystems Using Polymer Materials], 2011, a dissertation at the Institut für Mikrosystemtechnik—IMTEK, it is already known to build hybrid-type microsystems that include a multitude of micromechanical and microelectrical components. The individual components are disposed in several layers in such a way that closed microfine channels are created. To do so, rectangular or trapezoidal depressions are developed at the surface of a first component, which are covered by a further component with the aid of laser welding. The further component may be developed as cover foil or carrier material and absorbs the laser radiation that is conducted through the first component. Depending on the application case, the micromechanical channels produced in this manner may be developed in a pressure-resistant and tight manner for hydraulic and/or fluid applications. A laser-transparent and thermoplastic material, preferably a polymer material, is used as material for the components. The laser radiation travels through the transparent (first) component provided with the channels and heats the boundary area between the transparent (first) component and the laser-absorbing (further) component/carrier material, so that the materials melt and form a welding seam that is pressure- and gas-tight. A microsystem structured in this manner may be used as a micro laboratory on a chip, also referred to as a lab-on-chip cartridge, in conjunction with micromechanical and microelectrical sensors, for the purpose of analyzing fluids, for example.

It is furthermore known from the printed publication by Jochen Rupp “Multilayer Pressure Driven Microfluidic Platform—μFLATLab”, 2011, a dissertation at the Technical Faculty of the Albert-Ludwigs University Freiburg, to control fluids in the channels on a disposable polymer chip with the aid of integrated diaphragm valves and pumps. The activation of the diaphragm valves and pumps takes place via integrated hydraulically controllable channels, which are operated remotely from an external processing station.

It is essential for the method of functioning of the lab-on-chip cartridge that the welding joints between the individual components be pressure- and gas-tight within the framework of the specifications, so that the channels created thereby are tight both with respect to fluids and gases.

However, transverse sections in the region of the channels have shown that the welding seams are not always reliably tight. The welding seams in the regions underneath the channels, in particular, may be irregular or not tight.

### BRIEF SUMMARY OF THE INVENTION

It is an object of this invention to improve a method for developing a welding seam between a component that has a channel, and a body in such a way that the welding seam is developed to be tight and continuous.

In the proposed method, a first component provided with a channel is used, the latter having a rounded surface in cross-section along a plane in which a laser beam is guided, the rounded surface being developed in such a way that a specified power density of the laser beam is retained along the trajectory. This enables continuous, tight welding of the component to the body along the irradiated trajectory.

When the laser beams travels through the component, a steady, uniform refraction of the laser beam occurs at the walls of the channel. Harmful reflections with a strong shadow development on the body along the trajectory are largely avoided. This advantageously leads to more uniform heating of the material at the welding location along the trajectory underneath the channel, and consequently to a better and more reliable welding seam.

In one specific embodiment, the rounded surface of the channel is developed in such a way that the laser beam emerging from above through the rounded surface of the channel strikes at an angle between 90° and 70° with respect to the surface of the channel. At these angles a relatively uniform refraction of the laser beam without strong shadow formation is possible, which allows uniform welding of the first to the second component.

In one specific embodiment, the laser beam is oriented at a constant angle with respect to the upper surface of the first component in the movement along the trajectory, which allows simple guidance of the laser beam.

In one further specific embodiment, the laser beam is aligned at a varying angle with respect to the first component in the movement along the trajectory, in order to maintain the specified angle between 90° and 70° in a varying curvature of the channel. This method has the advantage that the surface of the channel may also have curvatures that feature small radii in the cross-section of the guidance plane of the laser beam. The risk of reducing the power of the laser radiation as a result of a discontinuous refraction or reflection at the surface of the channel is avoided by a corresponding alignment of the laser beam.

One preferred and advantageous development of the geometry of a channel according to the present invention is achieved by a semicircular cross-section having a radius R. This form is able to be produced in a very simple and cost-effective manner, for instance by embossing.

The first and second components may be made from a thermoplastic material. In addition, the second component may be developed as a cover foil in one specific embodiment.

In an Alternative development of the present invention, the cross-section of the channel is developed in the form of a semi-ellipsis, or in parabolic or hyperbolic form. Said geometries are easy to develop and can be obtained by hot-stamping, injection molding or milling, for instance.

In another development the device is developed at least as part of a lab-on-chip system. For example, it is also possible to weld multiple components provided with channels in any combination in multiple layers in order to form a micromechanical system (lab-on-chip cartridge). Such a micromechanical system may be used for controlling chemical and biochemical reactions or for analyzing materials. As a result, a compact design of the lab-on-chip system is possible.

Several specific embodiments of the present invention are shown in the drawing and explained in greater detail in the subsequent description.

### BRIEF DESCRIPTION OF THE DRAWINGS

FIG. 1 shows a cross-section of a known component having a trapezoidal-shaped channel.

FIG. 2 shows a plan view of a known component, in which a typical profile of the channel and welding seam is illustrated by way of example.

FIG. 3 shows the deflection of the laser radiation at a trapezoidal-shaped channel according to the related art in a schematic representation.

FIG. 4 shows a first exemplary embodiment of the present invention featuring a rounded geometry of a channel, as well as its beam characteristic.

FIG. 5 shows a second exemplary embodiment of the present invention.

FIG. 6 shows a third exemplary embodiment of the present invention.

### DETAILED DESCRIPTION OF THE INVENTION

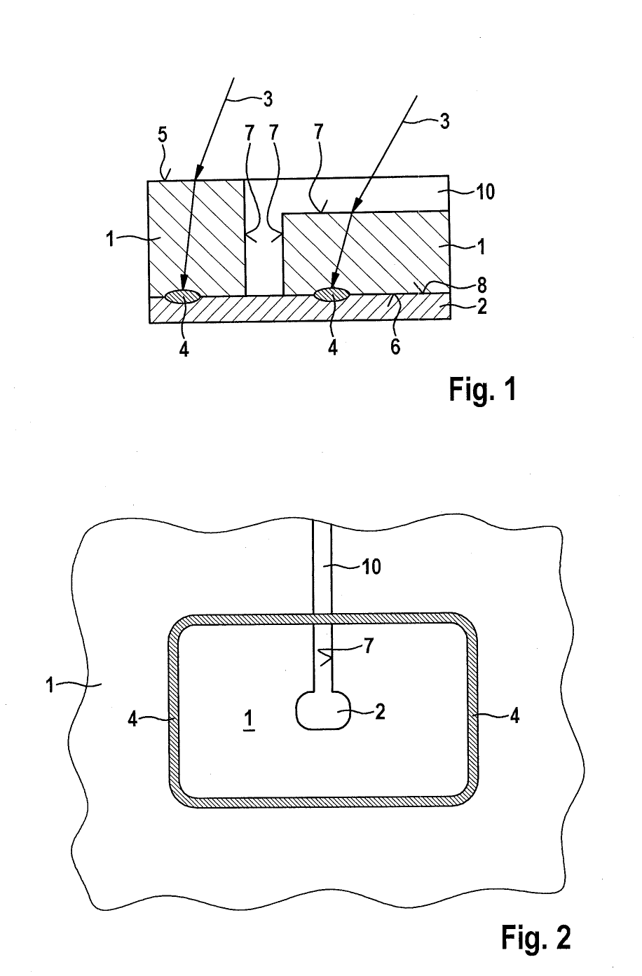

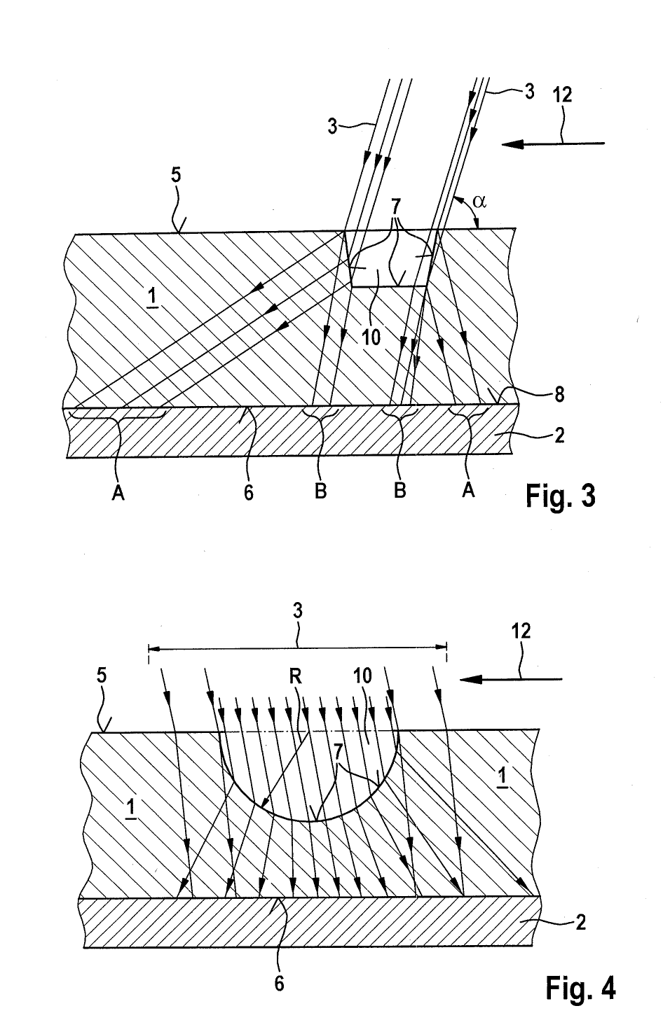

For a better understanding of the present invention, first FIGS. 1 and 2 will be used to illustrate on a first component 1 how the beam characteristic of laser 3 runs through first component 1. FIG. 3 shows how the laser beam is deflected at a channel 10 having a rectangular form.

FIG. 1 shows a laser-transparent thermoplastic component 1 in cross-section, which is welded to a second component 2 at two welding seams 4. A material is considered transparent when more than 50% of the output of the laser beams penetrates the component. Second component 2 is developed as a laser-absorbing thermoplastic cover foil. A material is considered absorbent when more than 50% of the output of the laser beams is absorbed in the material. The welding, i.e., the formation of welding seams 4, is accomplished with the aid of a laser beam 3, which impinges upon first component 1 at an upper surface 5, radiates through first component 1 and impinges upon an upper side 8 of second component 2 via a lower surface 6 of first component 1. Second component 2 absorbs the laser radiation, while the material of the first and/or second component is heated. The heating is so great that the material melts at irradiated regions 4. The laser beam is moved further, so that the melted material cools and welding seam 4 is created between the two components 1, 2.

An angled channel 10 is formed on first component 1. If laser beam 3 (left in the drawing) strikes first component 1 directly, the laser beam is inwardly deflected at upper surface 5, radiates through first component 1 and impinges upon top surface 8 of second component 2. For right laser beam 3, laser beam 3 first radiates through channel 10 before laser beam 3 is deflected at top surface 7 of channel 10.

FIG. 2 shows a plan view of a cutaway of first and second components 1, 2, which are welded to each other by a welding seam 4. A channel 10 and an annular welding seam 4 are visible on first component 1. Annular welding seam 4 crosses channel 10. When viewed in space, channel 10 is disposed above welding seam 4 in first component 1. Channel 10 is developed in quadratic, rectangular or trapezoidal form in cross-section along welding seam 4. Laser beam 3 is guided along a trajectory across first component 1 for the welding operation. During the welding laser beam 3 is deflected by refraction or total reflection at top surface 7 in the region of channel 10, such that the output of the laser beam becomes weaker. As a result, there is insufficient energy available to form a continuous welding seam 4. Interruptions therefore occur in welding seam 4, or welding seam 4 becomes too thin. The deflection of laser beam 3 by the angular geometry of channel 10 consequently prevents tight welding at the deflected, insufficiently irradiated regions along the trajectory of welding seam 4. This process will be discussed in the following text.

The principle of the deflection of laser beam 3 at the sides of a trapezoidal-shaped channel 10 is shown in detail in FIG. 3, which shows a first component 1 according to the related art. Laser beam 3 is guided across first component 1 along a movement trajectory 12. In one specific embodiment laser beam 3 has a constant angle of incidence α with respect to upper surface 5 of first component 1. The angle of incident lies between 70° and 90°. Upper surface 5 is essentially planar. First component 1 has a trapezoidal-shaped channel 10, which is open in the upward direction. On the left and right, laser beams 3 are heavily deflected at the walls of channel 10, since the angle of incidence of the laser radiation on the top surface is less than 70° as a result of the alignment of top surface 7 of the channel. By deflection, reflection and refraction at top surface 7 of the channel, an additional intensity of the laser radiation is produced in left region A. An additional intensity of laser radiation 3 due to a total reflection results in right region A. In regions B, on the other hand, the radiation is reduced by vignetting, so that an unsatisfactory welding seam having gaps may result in that location.

FIG. 4 depicts a first exemplary embodiment of the present invention. In contrast to the known related art of FIG. 3, channel 10 is developed with a rounded geometry in this case, i.e., a rounded top surface 7 at least in a plane along the movement trajectory of laser radiation 3. The channel cross-section is developed in a semicircular form and a radius R, for instance. Laser radiation 3 impinges upon component 1 at upper surface 5 along movement trajectory 12, and upon top surface 7 of channel 10 at an angle of incidence α. Since channel 10 has a rounded surface 7 in a plane in which the laser beam is guided, and since rounded surface 7 is developed in such a way that laser beam 3 traveling through rounded surface 7 of channel 10 impinges at an angle of incidence between 90° and 70° with respect to surface 7 of channel 10, a predefined power density of laser beam 3 in the irradiation of first component 1 remains unchanged along trajectory 4 up to top side 8 of second component 2. As a result, a continuous welding path along irradiated trajectory 4 is formed between first and second component 1, 2.

In the specific embodiment described, laser beam 3 is aligned at a constant angle with respect to upper surface 7 of first component 1 in the movement along the trajectory, i.e., along welding seam 4. This allows a simple guidance of laser beam 3.

In one further specific development, the laser beam is aligned at a variable angle with respect to the upper surface of the body in the movement along movement trajectory 12, so that the predefined angle between 90° and 70° with respect to top surface 7 of channel 10 will be maintained even if the curvature of top surface 7 of channel 10 varies. Depending on the geometry of channel 10, i.e., the curvature or alignment of top surface 7 of channel 10, the guidance of the laser beam may be quite complicated. However, this method has the advantage that top surface 7 of channel 10 may also have curvatures featuring small radii or edges in a cross-section of the guidance plane of the laser beam.

If channel 10 has a surface in the form of a circular arc in cross-section, then incident laser radiation 3 is uniformly deflected by the circular arc according to the principle of a dispersive lens, so that a laser intensity featuring a virtually constant value is obtained along trajectory 4 on upper side 8 of second component 2, as it is also produced when the irradiation strikes component 1 directly. This behavior comes about both in a vertical irradiation and an oblique irradiation of the laser. Because of the improved distribution of laser radiation 3, a reliable and gap-free welding seam 4 between the two components 1, 2 is able to be developed underneath channel 10 as well.

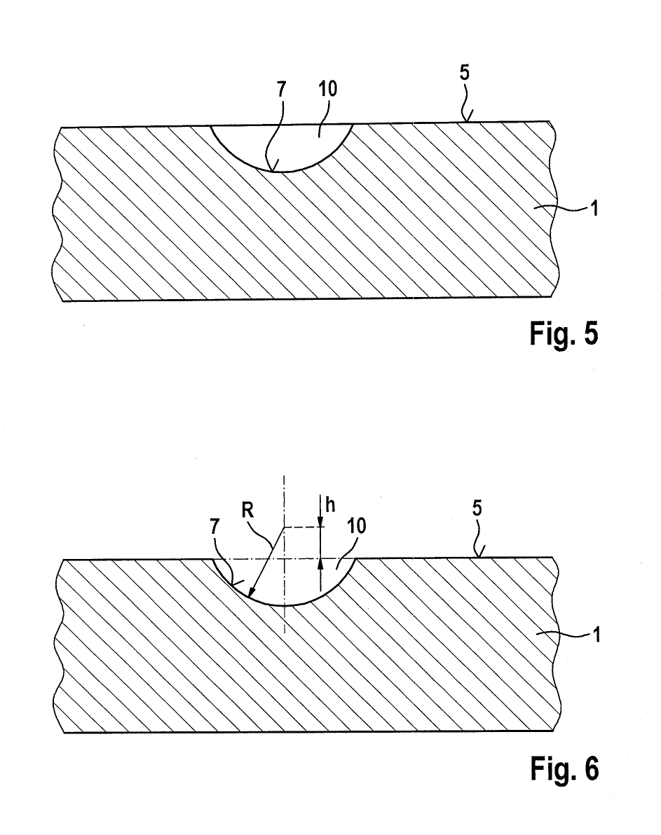

In another exemplary embodiment of the present invention, surface 7 of channel 10 in component 1 is developed as one half of an ellipse or as an ellipse segment according to FIG. 5. In an alternative development of the present invention, any round form, such as a hyperbolic or parabolic form, can be provided for surface 7 of channel 10.

A third exemplary embodiment of the present invention is shown in FIG. 6. As already described earlier, surface 7 of channel 10 is developed as a circle segment in component 1, the center point of the circle segment being shifted in the upward direction by value h of the circle segment. This makes it possible to develop a broader and flattened channel 10.

As already discussed, component 1 having at least one channel 10 is used to construct a micromechanical system, which is referred to as a lab-on-chip cartridge. Such a system is only a few square millimeters in size and has a micro-channel system in which the channels have a width or depth in the range of 20 to 200 μm, for instance. The channels can be produced in a cost-effective and reproducible manner by injection molding, hot-stamping or deep-drawing. Chemical or biochemical reactions or analyses are able to be carried out with the aid of a lab-on-chip cartridge, which would otherwise have to be performed by hand in the lab in a time-consuming manner. Such a system is also of special interest for diagnostic investigations, because only the smallest fluid quantities are required. The transportation of the fluids within the channel system and the created reaction chambers takes place with the aid of capillary forces, centrifugal forces or surface wetting effects. As an alternative, valves and pumps are used, which are situated on the polymer chip or in an external processing station and control the system.

What is claimed is:

1. A method for welding a first component having a channel to a second component, comprising:
placing a lower surface of the first component onto an upper surface of the second component; and
transmitting a laser beam through the first component and onto the upper surface of the second component, the laser beam furthermore being guided along a trajectory across the upper surface;
wherein the second component absorbs the laser beam along the irradiated trajectory, so that the irradiated trajectory of the second component is welded to the lower surface of the component in the form of a welding path, and wherein the channel has a rounded surface in a plane in which the laser beam is guided, and the rounded surface is configured in such a way that a predefined power density of the laser beam is present on the upper surface so that a continuous welding path is provided between the first component and the second component along the irradiated trajectory.

2. The method as recited in claim 1, wherein the rounded surface of the channel is configured in such a way that the laser beam impinges at an angle between 90° and 70° with respect to the surface of the channel.

3. The method as recited in claim 1, wherein the laser beam is aligned at a constant angle with respect to the first component in the movement along the trajectory.

4. The method as recited in claim 1, wherein the laser beam is aligned at a varying angle with respect to the first component in the movement along the trajectory, so that a predefined angle between 90° and 70° is maintained when the curvature of the channel varies along the trajectory of the laser beam.

5. The method as recited in claim 1, wherein the channel has a semicircular cross-section having a radius in the plane of the trajectory guidance of the laser beam.

6. The method as recited in claim 1, wherein the cross-section of the channel is in the form of one of: a half ellipse; a parabolic form; or a hyperbolic form.

7. The method as recited in claim 1, wherein the first component is dyed with a dye which is transparent for the laser beam.

8. The method as recited in claim 5, wherein the at least one channel is produced by one of: hot-stamping; using an injection molding process; or milling.

9. The method as recited in claim 1, wherein the first component is made of a thermoplastic material which is transparent to the laser beam, and the second component is made of a thermoplastic material which absorbs the laser beam.

10. A device, comprising:
a first component provided with at least one channel; and
a second component;
wherein:
a lower side of the first component rests on an upper side of the second component;
the lower side of the first component is welded to the upper side of the second component along a trajectory;
the first component is transparent for laser beams;
the second component absorbs the laser beams; and
the channel has a rounded surface at least in a plane that is aligned in a direction normal to the upper side and extends along the trajectory.

11. The device as recited in claim 10, wherein the first component is formed from a thermoplastic material.

12. The device as recited in claim 11, wherein the first component is formed from a temperature-stable polymer material.

13. The device as recited in claim 12, wherein the second component is in the form of a thermoplastic cover foil.

14. The device as recited in claim 13, wherein the device is a part of a lab-on-chip system.
